(19) United States
(12) Patent Application Publication
(10) Pub. No.: US 2014/0369694 A1
(43) Pub. Date: Dec. 18, 2014

(54) DISPERSION DOMINATED OPTICAL COMMUNICATIONS SYSTEM AND METHOD OF PRE-DISPERSION

(71) Applicants: Sergei Turitsyn, Oldbury (GB); Mariia Sorokina, Birmingham (GB)

(72) Inventors: Sergei Turitsyn, Oldbury (GB); Mariia Sorokina, Birmingham (GB)

(21) Appl. No.: 13/917,670

(22) Filed: Jun. 14, 2013

(51) Int. Cl. H04B 10/2507

(52) U.S. Cl. CPC H04B 10/2507
USPC 398/159

(57) ABSTRACT

Communication transmission system and method are disclosed based on introducing a large pre-dispersion of optical signal before launching the signal into an uncompensated communication system. The pre-dispersion has the same sign as dispersion of a transmission fibre. The aim of the method is to improve the transmission quality and simplify the digital signal mitigation of nonlinear impairments after the transmission. In the preferred embodiment, the optical system is a coherent communications system with any symbol rate, modulation format and/or carrier wavelength.

### CROSS-REFERENCE TO RELATED APPLICATION

This patent application claims priority to the U.S. Provisional application No. 61/662,638 filed on Jun. 21, 2012.

### FIELD OF INVENTION

The present invention relates broadly to an optical signal transmission systems and methods for various types of applications where pre-dispersion improves transmission via suppressing and simplifying impact of nonlinearity. More particularly, the present invention relates to a long-haul optical fiber communications, offering a way to reduce impact of fiber nonlinearity and also making it treatable for digital signal processing in order to improve the system performance.

### BACKGROUND OF THE INVENTION

Optical fiber communication is a communication technique(s) enabling short/long-distance data transmission using an optical fiber as a signal propagation medium.

When information is transmitted over such fiber optic communication lines, impairments to the pulse of light carrying the information inevitably occur. This includes pulse broadening (dispersion) and attenuation (energy loss).

Generally, signals are modulated before transmission. A modulated optical signal naturally has various widths in frequency. In other words, the optical signal is transmitted at various frequencies for each component of the optical signal, having the high-frequency components move at different speeds (through the fiber optic material) comparing to the low-frequency components. Hence, the time between the faster and the slower components increases during the transmission, causing the pulse broadening and interference with the neighboring pulses,—the phenomenon known as a chromatic dispersion. For a long-haul communication, a wave-division-multiplexing (WDM) large-capacity optical communications is usually utilized with a plurality of signals transmission having wavelengths different from each other. For the WDM optical communications, light in 1530 nm to 1560 nm is typically used, since the transmission loss of silica-based optical fiber lines is small in this wavelength band.

Er-doped optical fiber amplifiers (EDFA) installed periodically along the lines enhance the signals compensating periodically for signal power attenuation due to fiber loss. Use of optical amplifiers introduces the optical noise into the transmission system leading to degradation of the quality of transmission.

Examples of transmission lines applicable to WDM optical communications in the 1.55 micrometer range include a single-mode optical fiber (SMF) having a zero-dispersion wavelength in a 1.3 micrometer wavelength band. Since the single-mode optical fiber has a large positive (the so-called anomalous) dispersion in the 1.55 micrometer range, the single-mode optical fiber and a dispersion-compensating optical fiber (dispersion compensator) having a large negative dispersion in that range are often combined together, so as to compensate for dispersion in the 1.55 micrometer range. The compensation of the SMF dispersion can be done before transmission, after transmission and in-line. In coherent communication the SMF dispersion is left uncompensated in the optical domain and the electronic post processing is applied after transmission in the electrical domain providing for effective electronic dispersion compensation. This regime is often called uncompensated transmission meaning that transmission fiber dispersion is not compensated in the optical domain (with dispersion compensating fibers or other optical elements) but is rather compensated electronically. Effects of noise and nonlinearity (due to Kerr effect in optical fiber) are the two main sources of errors in transmission after dispersion is compensated optically or electronically.

Larger network capacities are demanded in optical communications, and that's why the task of combating nonlinearities is quite urgent. Nonlinear propagation effects in optical fiber communications combined with dispersive signal broadening and additive noise, in general, make impossible simple analytical description of the system transfer function that would link the output (received) optical field to the input (transmitted) field. In mathematical terms, the fiber communication channel is described by the stochastic nonlinear partial differential equations. Therefore, analysis of statistical properties of the channel requires extensive numerical modeling. Lack of simple channel model impedes both theoretical analysis of channel capacity and application of engineering techniques, signal processing and coding algorithms available, for instance, for a seminal additive white Gaussian noise channel.

The pulse broadening can be corrected using the chromatic dispersion compensation. Various chromatic dispersion compensation techniques have been reported in literature, operating in optical or digital domain.

For example, the U.S. Pat. No. 6,275,315 entitled “Apparatus for Compensating for Dispersion of Optical Fiber in an Optical Line” by Park, discloses a method in which dispersion compensation fiber is used in conjunction with a variable dispersion compensation module (DCM). The variable dispersion compensation module plays the role of a dispersion compensation filter such as a reflective tunable etalon filter allowing for variable dispersion compensation.

Yet another example is disclosed in the US application #20120197769 titled “Chromatic Dispersion Compensation System And Method” by Eiselt, which discloses the DCMs that employs first and second transceivers and a plurality of amplifiers (of different granularity) coupled to the optical channel that are spaced throughout the transmission line with variable span distances. A memory is associated with the dispersion compensators to provide information related to the value of the dispersion compensation.

Since the amount of wavelength dispersion increases in proportion to the distance and different types of optical fibers have different characteristics, it is desirable to use different DCMs depending on distances and the types of optical fibers. Determining the locations and the characteristics of DCMs on the network is called dispersion compensation design. Thus, the US application #20120141137 titled “Dispersion Compensation Design Method And Dispersion Compensation Design System” by Tajima discloses a changing unit setting a changed value for the amount of dispersion compensation for a span connecting nodes constituting an optical network.

Recent progress in high-speed optical fiber communications is based on the technology of coherent detection with digital signal processing (DSP) to mitigate transmission impairments. Knowledge of an optical phase in addition to field intensity after coherent detection dramatically changes the whole concept of compensation and management of impairments in fiber-optic communication. In particular, linear effects such as dispersion and polarization-mode dispersion can be compensated entirely at the coherent receiver. Electronic signal processing using back-propagation has also been applied to the compensation of nonlinear fiber impairments.

Electronic dispersion compensation (EDC) has attracted interest due to extending reach under the multimode optical fiber legacy, as well as in metro and long-haul optical transmission systems. The advantages of EDC (compared to the optical-domain compensation) include the reduced costs by eliminating the DCM installation and loss compensation cost; simplification of the deployment and network configuration; compensation flexibility required in dynamic optical network; simplified transmitter/receiver integration, etc. EDC can be categorized into transmitter-side and receiver-side.

For example, the US application #20120155881 titled “Electronic Dispersion Compensation System and Method” by Zhao discloses the use of the amplitude and instantaneous frequency information of a received distorted optical signal, and an electrical circuit adapted to perform a full-field reconstruction of the received distorted optical signal using the electrical signals. The compensation parameters updated at a selected rate to process the reconstructed signal and compensate for coarse chromatic dispersion and fine impairment compensation. The system and method of the invention achieves low-cost long-distance transmission, while maintaining the fast-adaptive compensation capability and provide a method for transparent long-haul and metro-optical networks.

However, the drawback of the methods of reconstruction of the transmitted data from the received signal based on nonlinear backward propagation is that they rely on computationally intensive techniques. The real time nonlinear digital backward propagation is still a challenging problem. It would be vitally important for development of the efficient DSP techniques capable to mitigate nonlinear impairments to have models (at least in some limits) of the nonlinear fiber channels, which can be treated analytically or semi-analytically.

To conclude, all the methods have been developed to compensate for the wavelength dispersion at the each receiving node of the communication network are based on the optical or electrical signal processing by a various types of DCM, all dealing with the dispersion compensation characteristics that are opposite to those of optical fibers constituting the transmission path.

Alternatively, the present invention discloses a transmission technique based on a very large dispersive stretching, i.e. a pre-dispersion having the same sign as dispersion of a transmission fiber, of optical signal before uncompensated (in the optical domain) fiber transmission in communication systems with the aim to improve quality of transmission and to simplify the following digital signal processing. In the preferred embodiment, the optical system is a coherent communications system using any symbol rate, any modulation formats and any carrier wavelengths.

The disclosed pre-dispersion technique is directly opposite to previously-used pre-compensation, having the same sign of dispersion broadening. In pre-compensation dispersion has the sign opposite to the dispersion of the transmission fiber—leading to partial or complete compensation of the overall accumulated dispersion. In the proposed technique the dispersion before transmission has the same sign as the dispersion of a transmission fiber and is added to the dispersion of a transmission fiber making the total accumulated dispersion larger. In the preferred embodiment the amount of pre-dispersion compared to the link dispersion is from 0.1:1 to 1:1.

The pre-dispersion is introduced either in optical domain or electronically. A variety of devices may be used to achieve the required pre-dispersion: fiber Bragg gratings, long period gratings and waveguide dispersive elements, any meta-material based highly dispersive elements, or other. This technique may be used in long haul communications, and especially in transatlantic link with the length over 5,000 km. In order to increase the transmission capacity, the information coded over phase or signal amplitude or both. In the preferred embodiment, the pre-dispersion is introduced after the data is embedded. In one embodiment, the optical beam comprises RZ pulses, and in the other embodiment—NRZ pulses.

### SUMMARY OF THE INVENTION

The invention discloses an optical communications method for a data transmission in nonlinear optical fiber link. Accordingly to the method, a signal pre-dispersion is introduced (either in optical domain or electronically) prior to sending the data via the optical link. By keeping the pre-dispersion sign the same as the sign of the optical link average dispersion, the signal dispersion is increased when the signal arrives at a receiver. By these means, while launching the pre-dispersed signal into the line and having many properties of a noise-looking waveform, the mitigation of signal distortion due to the link nonlinearity is possible, thus improving a communications system performance.

In some embodiment of the disclosed method, the ratio between the pre-dispersion amount and the link dispersion is in the range between 0.1:1 and 1:1. Moreover, the method is applicable to long-haul communication, such as an M-PSK or QAM transatlantic link at wavelength of 1.55 micrometers with a 40 Gb/s transmission rate, for example. In general, such a coherent communications systems can use any symbol rate, modulation format or carrier wavelengths. Moreover, the temporal pulsed signal with RZ or NRZ pulses can be used.

An optical system based on the method is also disclosed. The system consists of a light source, a pre-dispersion unit, a modulator and a receiver. The a pre-dispersion unit introduces a pre-dispersion into the signal prior to sending it into a transmission line, improving the system performance, such as diminishing the nonlinearity of the modulated signal (e.g a lower BER), or by using a knowledge of the derived conditional probability by enabling (due to the large pre-dispersion) an analytical channel description for the input signal at the transmitter. Such knowledge can be defined in a digital signal processing, signal modulation, signal coding, or error correcting coding. Moreover, the transmission capacity can be improved by approaching the Shannon capacity limit for additive white Gaussian noise channel.

The pre-dispersion can be introduced in electronic domain through the digital signal pre-processing or optically, using fibre Bragg gratings, long period gratings, waveguide dispersive elements or meta-materials. The system also uses a dispersion compensation unit at the receiver to facilitate the information recovery after transmission. Moreover, the pre-dispersion can be introduced to the signal after the modulation (information encoding).

### BRIEF DESCRIPTION OF THE DRAWINGS

FIG. 1: Block-diagram of the optical communication system using the disclosed method of pre-dispersion.

FIG. 2: Prior Art: The block-diagram of a coherent receiver.

FIG. 3: The comparison of the numerical simulations and the derived analytical formula. The comparison of the full numeric with the analytical model is shown.

FIG. 4: Prior Art: Dispersion compensation device based on Bragg gratings.

### DETAILED DESCRIPTION OF THE PREFERRED EMBODIMENT

The discloses invention is based on a system and method of modifying an optical signal before its propagation through the optical fiber by artificially introducing a large pre-dispersion that has the same sign as a fiber dispersion that is naturally introduced to the optical signal during (uncompensated) propagation.

The method and system are specifically optimized for transmission using coherent communication systems with a nonlinear channel. Since in such communication system the spectral dynamics of the signal can be described analytically, the method can significantly simplify the following DSP.

Within the limit of a very strong initial pre-dispersion, the nonlinear propagation equations for each spectral component of the signal become local and decoupled, resulting in a relatively simple input-output signal mapping, which, in turn, opens a possibility of fast DSP nonlinear effects compensation.

The basic approach of the disclosed invention includes an imposing of a very large pre-dispersion modification of the signal without introducing a substantial loss to the signal. This can be done either by optical devices or using electronic signal pre-processing.

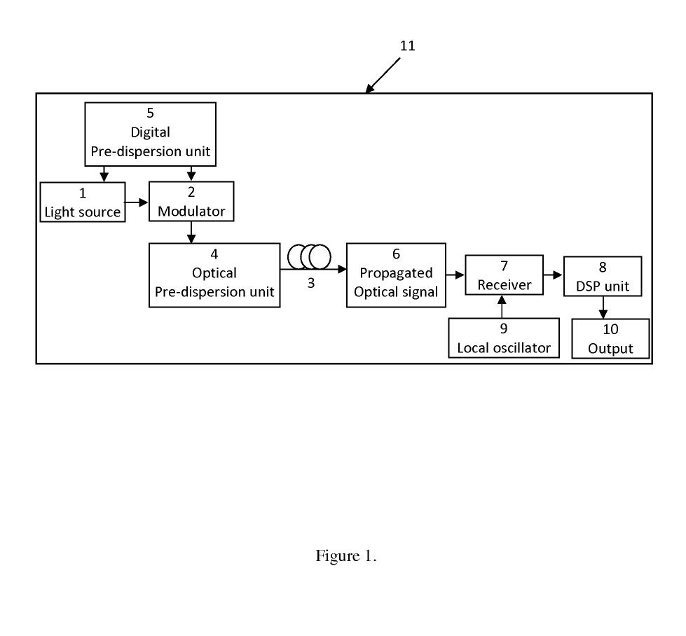

FIG. 1 shows schematically the basic elements of the advances communication system proposed in the present patent application. A light source 1 produces modulated with data using a modulator 2. Without loss of generality our approach is illustrated here using Quadrature Amplitude Modulation (QAM) format for communication operating at high data rates. In the preferred embodiment without loss of generality the modulator 2 is a QPSK or QAM modulator.

A pre-dispersion unit is capable of introducing the (artificial) dispersion to the modulated signal either by using optical dispersion means, such as unit 4, or by digital (DSP) means, such as unit 5.

Without the pre-dispersion introduced by 4 or 5, the modulated (by modulator 2) signal propagates through a communication link 3 (channel, e.g. fiber) producing a propagated optical signal 6 with naturally acquired dispersion during the propagation.

When the pre-dispersion is used, the pre-dispersion unit (4 or 5) introduces dispersion to the communication channel 3. It is important to emphasize that the pre-dispersion (introduced by 4 or 5) has the same sign as a naturally occurred dispersion in an optical channel 3.

With the pre-dispersion introduced by 4 or 5, the modulated (by modulator 2) signal propagates through a communication link 3 (channel, e.g. fiber) producing a propagated optical signal 6 having: i) the naturally acquired dispersion, ii) the introduced pre-dispersion, and iii) the naturally acquired dispersion and the introduced pre-dispersion having the same sign.

An optical receiver 7 receives the propagated optical signal 6. In a preferred configuration of the invention, the coherent receiver 7 combines the incoming signal 6 with a signal from a local oscillator 9.

An output signal from the (coherent) receiver 7 is processed in DSP unit 8 to recover the data sent. A resulting output 10 from the communication system 11 may be further utilized or used for further processing.

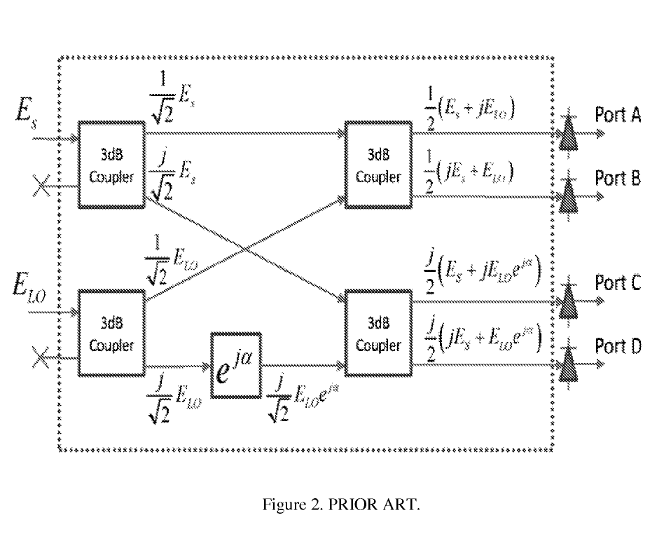

The typical coherent receiver 7 shown in FIG. 1 is further explained in FIG. 2, accordingly to the U.S. Pat. No. 7,3279,13 by Shpantzer et al.

Recent progress in coherent optical communication, a field revived by advances in digital signal (post)-processing (DSP). DSP-based phase and polarization management techniques make coherent detection robust and practical. With coherent detection, the complex field of the received signal is fully recovered, allowing compensation of linear impairments including chromatic dispersion and polarization-mode dispersion using digital filters.

We would like to stress that this invention is opposite to the well-known pre-compensation technique. Unlike to the existing methods, we disclose a use of an (artificial) application of a large pre-dispersion having the same sign as the transmission link dispersion.

The key idea behind such initial pre-dispersion is that the imposed fast spectral oscillations of the signal (associated to the pre-dispersion) simplify their subsequent dynamics. Since the highest spectral modes can be effectively averaged out, the propagation equations become integrable.

The proposed system and method lead to relatively simple communication channel description without assumption that the level of nonlinearity is necessarily small i.e. it works even beyond the applicability region of a quasi-linear regime.

An exact analytical description of an optical field transfer-function in nonlinear fiber channel with uncompensated (in optical domain) dispersion can be derived in the limit of very large initial pre-dispersion. Thus, the averaged evolution of the two orthogonal polarizations of the field envelope [U₁(z, t), U ₂(z, t)] of the optical field along the fiber is well approximated by the Manakov equations:

$$\frac{\partial {U}_{1}}{\partial z} = - \frac{α}{2} {U}_{1} - i \frac{{β}_{2}}{2} \frac{{\partial }^{2} {U}_{1}}{\partial {t}^{2}} + i \frac{8 γ}{9} J \times {U}_{1} + {η}_{1} , \\ \frac{\partial {U}_{2}}{\partial z} = - \frac{α}{2} {U}_{2} - i \frac{{β}_{2}}{2} \frac{{\partial }^{2} {U}_{2}}{\partial {t}^{2}} + i \frac{8 γ}{9} J \times {U}_{2} + {η}_{2} , \qquad ( 1 )$$

where J=|U₂|²+|U₁|² is the nonlinearity averaged over polarization inhomogeneities; β₂, γ, η_{1,2} and α are the group velocity dispersion, nonlinear coefficient, distributed additive noise and linear loss, respectively. We focus here on deterministic nonlinear dynamics and introduction of a simplified nonlinear propagation model. As a result of linear pre-dispersion the input optical signal (which we here consider to have finite initial optical bandwidth B) acquires a quadratic shift in the spectral phase. After the propagation we apply the post-processing loop that fully compensates both the initial pre-dispersion and the total amount of accumulated transmission dispersion. Mathematically the procedure can be described by introducing the compensated optical fields, A_{1,2} in the ω domain related to the original envelope via:

Uₙ(z,t)=∫dωe^{αz/2+iωt iω}^{²}^{(K-β}^{₂}^{z)/2} Aₙ(z,ω) (2)

The parameter K (measured in ps²) is the effective accumulated dispersion introduced by the pre-processing. Applying the transform (2) produces the pre-processed field(s) Uₙ(0,t), which is then launched into the fiber and evolves accordingly to (1).

The post-processing is inverting mapping (2) at the receiver, producing an effective output field(s) Aₙ(z,ω). For the new fields Aₙ the master propagation equation (1) can be rewritten in the following integro-differential form (with Aₙ(ω)≡Aₙ(z,ω)):

$$\frac{\partial {A}_{n} ( ωω}{\partial z} = i \frac{8 γ}{9} \int \int d {ω}_{1} d {ω}_{2} {e}^{- α z + i ( ω - {ω}_{1}} ) ( ω - {ω}_{2} ) ( K - {β}_{2} z ) \times \times {A}_{n} ( {ω}_{1} ) [ {A}_{n} ( {ω}_{2} ) {A}_{n} ( {ω}_{3} ) + {A}_{3 - n} ( {ω}_{2} ) {A}_{3 - n} ( {ω}_{3} ) ] . \\ where \\ n = 1 , 2 \\ and \\ {ω}_{3} = {ω}_{1} + {ω}_{2} - ω . \qquad ( 3 )$$

Effectively, the integration in Eq.(3) is restricted to the bandwidth window |w|<πB. Assuming that spectral oscillations due to dispersion K−β₂z have the smallest spectral scale (we stress that this is a rather strong requirement and modulation and coding should be adequately adjusted to satisfy this condition) it is possible to demonstrate that the nonlinear channel can be described analytically provided that the initial pre-compensation K is large enough (the specific inequalities are provided below).

The main idea of the disclosed approach is that as the accumulated dispersion |β₂|z becomes large the exponential term becomes highly oscillating and one can use a saddle point approximation to evaluate the integral and simplify the model. However, this does not account for the initial stages of evolution when |β₂|zB² is not large. Introduction of a sufficient pre-dispersion, K, at least, such that K B²>>1 one can use a saddle point approximation everywhere along the fiber to calculate the integral in Eq. (3) (here n=1,2):

$$\frac{\partial {A}_{n} ( z , ω )}{\partial z} = \frac{16}{9} \frac{{iπγe}^{- α z}}{K + \vert {β}_{2} \vert z} [ {\vert {A}_{n} \vert}^{2} + {\vert {A}_{3 - n} \vert}^{2} ] {A}_{n} \qquad ( 4 )$$

These equations are integrable:

$${A}_{n} ( z , ω ) = {A}_{n} ( 0 , ω ) exp [ \frac{16}{9} \frac{iπγ}{\vert {β}_{2} \vert} f ( α z , \frac{\vert {β}_{2} \vert z}{K} ) I ( ω ) ] \qquad ( 5 )$$

with I(ω)=|A₁(0,ω)|²+|A₂(0,ω)|² and f(x, y)=e^{x/y}(Ei[−x/y−x]−Ei[−x/y]), which in the lossless limit takes a simple form f[0,y]=ln(1+y). Here Ei(x) is the exponential integral function.

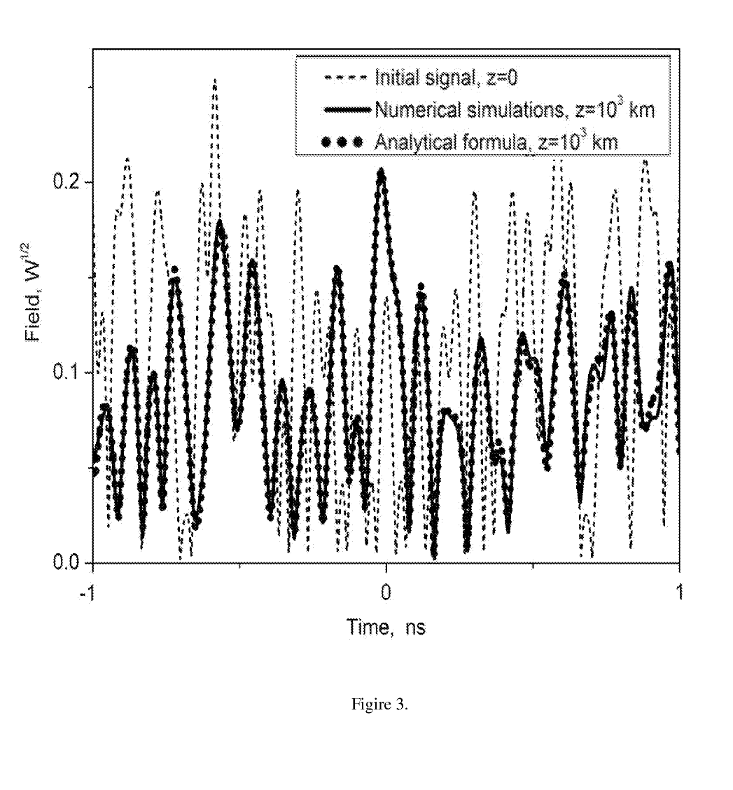

The validity of the analytical formula (5) was checked by numerical simulations of signal propagation with a single polarization, which is modeled by a scalar nonlinear Schrodinger equation. The FIG. 3 shows the good agreement between the analytical predictions and the numerical simulation for N=2⁶ symbols. A 4-level quadrature phase shift keying (QPSK) format was used to encode a pseudorandom sequence of symbols modulated in sinc waveform. It can be seen from the results that the large nonlinearity in the system is effectively suppressed by the proposed pre-distortion effect. The resulted distortion is accurately described by the analytical formula (dot line), which perfectly coincides with the numerical simulations (continues line), with the reference to the FIG. 3. The following typical parameters were used for the simulation: bandwidth B=300(b) GHz, propagation distance z=1000 km, group velocity dispersion) β₂=−20 ps²/km, nonlinear coefficient γ=1.2 km⁻¹W⁻¹, signal peak power P=12.4 (0.0175) dBm(W).

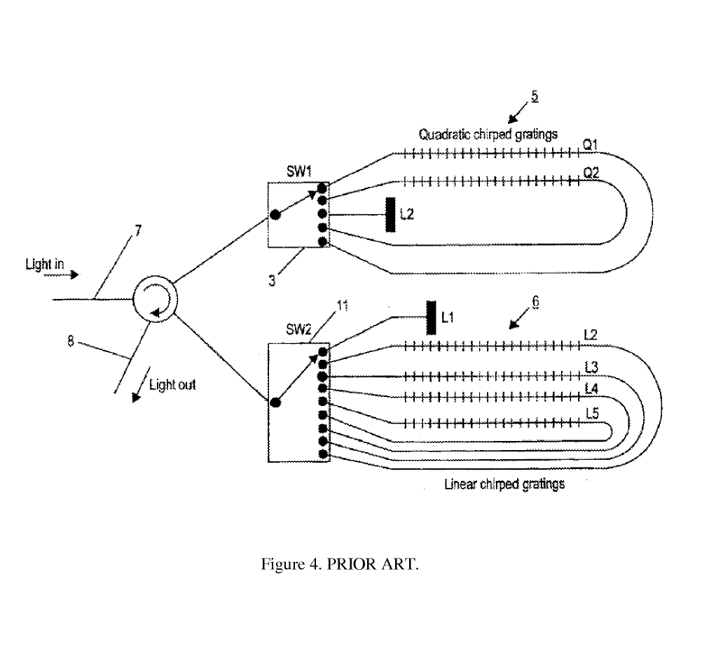

A variety of devices may be used as a dispersion module in the optical domain. For example, see FIG. 4, a dispersion compensation device based on Bragg gratings disclosed in US Patent application 20060127001 by Oikawa et al. may be used if modified to produce a positive, additive dispersion rather than compensating dispersion.

The proposed method and system is based on the large pre-dispersion of the same sign as the dispersion that occurs in the communication channel (fiber). The method and system are optimized for coherent communication systems with the simplified digital signal post-processing.

Although several exemplary embodiments have been herein shown and described, those of skill in the art will recognize that many modifications and variations are possible without departing from the spirit and scope of the invention, and it is intended to measure the invention only by the appended claims.

What is claimed is:

1. An optical communications method for data transmission in nonlinear optical fiber link, comprising:
introducing a signal pre-dispersion either in optical domain or electronically prior to sending the data via the optical link, wherein a pre-dispersion sign is the same as a sign of the optical link average dispersion thus increasing a signal dispersion when the signal arrives at a receiver site, launching a pre-dispersed signal into the link; the signal effectively having many properties of a noise-looking waveform,
receiving a signal with improved communications performance due to partial mitigating of a signal distortion caused by a link nonlinearity.

2. The method of claim 1, wherein a ratio of an amount of the pre-dispersion compared to the link dispersion is from 0.1:1 to 1:1.

3. The method of claim 1, wherein the optical link is more than 5,000 km.

4. The method of claim 3, wherein the optical link is a transatlantic link.

5. The method of claim 1, wherein a channel data transmission rate is at least 40 Gb/s.

6. The method of claim 1, wherein the signal has a wavelength of 1.55 micrometers.

7. The method of claim 1, wherein a data modulation format is M-PSK or QAM.

8. An optical system for data transmission, comprising:
a light source producing an optical beam, which is modulated with data in a modulator and sent to a receiver, wherein prior to sending a modulated beam into a transmission line, a pre-dispersion is introduced in a pre-dispersion unit, which allows achieving an improved system performance.

9. The optical system of claim 8, wherein the improved performance is in less effect of a link nonlinearity on the modulated beam.

10. The optical system of claim 8, further comprising: a dispersion compensation unit at the receiver to facilitate the information recovery after transmission.

11. The optical system of claim 8, wherein the optical system is a coherent communications system using any symbol rate, any modulation format and any carrier wavelength.

12. The optical system of claim 8, wherein the dispersion unit introduces an electronic pre-dispersion.

13. The optical system of claim 8, wherein the dispersion unit introduces the pre-dispersion in optical domain using fibre Bragg gratings, long period gratings, waveguide dispersive elements, or meta-material based highly dispersive elements, or introduces the pre-dispersion in digital domain through electronic digital signal pre-processing.

14. The optical system of claim 8, wherein the improved performance is in lower BER.

15. The optical system of claim 8, wherein the improved performance is in an improved capacity approaching Shannon capacity limit for additive white Gaussian noise channel.

16. The optical system of claim 8, wherein the improved performance is achieved using a knowledge of an analytically derived conditional probability P(Y|X) giving an output signal Y at the receiver provided that an input signal at the transmitter was X, analytical description of nonlinear fiber channel possible due to large pre-dispersion.

17. The optical system of claim 16, wherein the knowledge is in digital signal processing, signal modulation, signal coding, or error correcting coding.

18. The optical system of claim 8, wherein the optical beam is a temporal pulsed beam.

19. The optical system of claim 18, wherein the pulses are RZ or NRZ pulses.

20. The optical system of claim 19, wherein the dispersion unit introduces the pre-dispersion to the signal after the signal is information encoded.
